(19) United States
(12) Patent Application Publication
(10) Pub. No.: US 2010/0221449 A1
(43) Pub. Date: Sep. 2, 2010

(54) Method and apparatus for applying plastic coatings

(75) Inventors: Dirk Schlatterbeck, Fritschen (CH); Andre F. Ceppi, Galgenen (CH)

Correspondence Address: DeMont & Breyer, LLC, 100 Commons Way, Ste. 250, Holmdel, NJ, 07733, US

(73) Assignee: SCHMID RHYNER AG, Adliswil (CH)

(21) Appl. No.: 12/670,242

(22) PCT Filed: Jul. 24, 2008
(86) PCT No.: PCT/EP08/06086

§ 371 Date: Apr. 30, 2010

(30) Foreign Application Priority Data
Jul. 24, 2007 (DE) 10 2007 034 877.2

(51) Int. Cl. B05D 3/06; B05C 11/06; B05D 3/12

(52) U.S. Cl. 427/558; 118/63; 427/348

(57) ABSTRACT

The invention relates to an apparatus for applying coatings to surfaces of substrates in the form of paper, cardboard, or plastic films, preferably for finishing printed materials. The apparatus comprises
a coating unit for applying coating material in fluid form to the substrate surface, and
a device for smoothing the still fluid film applied to the substrate surface by the coating unit, the device including a unit for generating a gas stream which is directed onto the substrate surface coated with the film, and which smoothes the film while at least partially removing interfering structures on the film surface such as depressions, elevations, and craters before the coating material cures.

### FIELD OF THE INVENTION

The invention relates in general to the application of coatings such as varnishes, for example. The invention relates in particular to devices and measures for the targeted influencing of the surface structure of the still fluid film, for example smoothing of the applied coating films. In the present context, “smoothing” refers in particular to the removal of undesired structures or defects on the coating surface, as described in greater detail below.

### BACKGROUND OF THE INVENTION

As the result of the application method for varnishes or the substrate to be coated with a varnish or coating material, applied coating films may have undesired structures or defects. Such structures or defects may include, among others, roller structures, longitudinal structures from the roller transfer, longitudinal stripes from nonuniform application, or transfer defects during the coating application.

The substrate may be another reason for interfering surface structures. The surface characteristics of the substrate may result in structures or defects on the coating surface. For example, craters may form on the coating surface as the result of unwetted depressions in the substrate. This may occur in particular, but not exclusively, in contactless application of the coating material, especially in contactless application using nozzles.

The smoothing of coatings using doctor blades, air knives, air blades, or smooth rollers is generally known from the prior art. However, there is the problem that such processes cannot be used on laterally structured varnish layers in which, for example, portions of the surface coating are to be left uncoated (partial coating). When the treatment is carried out using a doctor blade or a roller, in addition to smoothing of the surface the still liquid varnish layer is distributed over the surface and also reaches areas which are to be left uncoated.

Furthermore, a method for smoothing layers is known from DE 44 43 261 A1, in which liquid or paste-like layers applied to a substrate are smoothed by use of ultrasound. For this purpose an ultrasonic oscillator is provided which transmits to the layer. For effective transmission of ultrasonic oscillations, the substrate having the layer is brought into contact with the ultrasonic oscillator from the back side, the substrate being curved or bent over the ultrasonic oscillator.

Smoothing of an applied film by use of ultrasound is also described in JP 59225772 A. In the cited document the coating is applied by roller. The substrate passes over a roller which is situated opposite from the ultrasonic oscillator. The ultrasound is injected on the layer side in a contactless manner via the air. Here as well, similarly as for DE 44 43 261 A1, the substrate is curved at the location of the ultrasound application.

Depending on the substrate, however, this may be undesired or impracticable, for example if the substrate is too rigid, or if damage is a concern. Since in both of the cases described above the direction of motion of the substrate in the respective device for the targeted influencing of the surface of the fluid coating material is changed, it is difficult to integrate such a design into existing facilities such as printing machines or print finishing units.

### SUMMARY OF THE INVENTION

The object of the invention is to eliminate or to smooth surface defects which occur in the coating application in order to produce a defect-free surface, regardless of the application method and substrate used.

It is a further aim of the invention to allow the travel distances in coating facilities to be reduced.

Accordingly, the invention provides an apparatus and a method for applying coatings to surfaces of substrates, wherein a coating unit is used for applying coating material in fluid form to the substrate surface, and a conveying device is used to move the substrate surface relative to the coating unit along a direction of travel past the coating unit. For this purpose the substrate is preferably moved past a stationary coating unit. However, it is also possible to keep the substrate stationary and to move the coating unit.

Also provided is a device for the targeted influencing of the coating surface, for example smoothing the still fluid film applied to the substrate surface by the coating unit. For this purpose, this device includes a unit for generating a gas stream which is directed onto the substrate surface coated with the film, and which smoothes the film while at least partially removing interfering structures on the film surface such as depressions, elevations, and craters before the coating material cures. The smoothing is thus carried out in a contactless manner by use of the gas stream.

In this regard, it is surprising that it is possible to achieve very effective removal of interfering structures in the film surface by use of the gas stream, without the coating material being transported over possibly longer distances along the surface. The transport of the coating material by the gas stream is preferably held to less than 1 mm, particularly preferably less than 0.25 mm, along the surface. The contours of the borders of coated areas particularly preferably remain completely uninfluenced by the smoothing. This means that coating material is not introduced into uncoated areas as a result of the smoothing.

The invention is particularly suitable in conjunction with a contactless coating application using a nozzle system. In this regard, a computer-supported control device for actuating the coating nozzles is also advantageous, so that also laterally patterned coatings, in this case in particular with omission of regions of the substrate surface, may be produced by corresponding control of the nozzles. It is particularly preferred to use a drop-on-demand coating unit having nozzles for delivery of individual droplets of the coating material in response to control signals. The nozzles of the coating unit are preferably arranged in at least one row transverse to the direction of travel.

In particular for a contactless method, such as for coating using a drop-on-demand or ink jet printing unit, the coating forms a film, in particular on porous substrates such as paper or cardboard, in which small craters or pits, i.e., pinholes, are distributed over the surface which detract from the desired appearance. These craters or pinholes are easily visible on gloss as well as matte coatings on printed materials. These depressions may occur even on coated paper or cardboard. By means of the invention, the number of these craters may be at least substantially reduced by action on the still unsolidified varnish or coating film in a very simple manner.

To achieve rapid application of the coating material by use of contactless coating, in particular the drop-on-demand technique, it is also particularly preferred that the nozzles of the coating unit are arranged in at least one row which is transverse to the direction of travel and which spans at least three-fourths of the processable substrate width perpendicular to the direction of travel, the nozzles preferably being rigidly mounted in the direction transverse to the direction of travel. The nozzles thus sweep over the entire region of the substrate to be coated by moving in only one direction, namely, the direction of travel.

For other coating methods as well, for example roller application or screen printing, undesired surface structures may likewise result from material splitting, among other causes, when the roller or screen separates from the substrate surface. In one refinement of the invention, the coating unit may therefore also include a roller application unit and/or a screen printing unit. In the case of coating by roller application, flexographic printing, rotogravure printing, and simple, full-surface roller coating in particular are also intended. In the flexographic printing process, the molding roller which is covered with a printing form rolls over the substrate and selectively applies the coating material to the substrate surface.

In rotogravure printing, the depressions of a selectively engraved cylinder are filled with coating material or printing ink. The cylinder is brought into direct contact with the paper, and the coating material or printing ink is transferred to the paper. In screen printing, by use of a semipermeable fabric the ink or coating material is transferred through the fabric and to the paper at the open locations, using a doctor blade. All of the referenced processes except for full-surface roller coating, the same as for the drop-on-demand technique, may also be used for laterally structured coating while leaving areas of the substrate surface uncoated.

It has been shown that a uniform gas stream is disadvantageous with regard to the smoothing effect. Thus, only a comparatively poor smoothing effect can be achieved by use of a slot die which sweeps over the surface with a uniform gas stream. Instead, it is beneficial to pass over the surface a gas stream which is varied with respect to the direction and/or flow velocity for the particular points of the surface to be smoothed. Measures for generating such a gas stream are outlined below.

In the simplest case, individual nozzles are used in a row or grid arrangement. It is advantageous for the device for generating a gas stream to include at least one row of gas nozzles extending transverse to the direction of travel.

To generate gas streams having a suitable velocity, inlet pressures at the nozzle(s) in the range of at least 1 bar, preferably at least 0.5 bar or at least 0.1 bar, have proven suitable. For larger nozzle diameters, higher pressures, for example up to 2 bar, 4 bar, 6 bar, or 12 bar, or if needed, even 20 bar, may also be used.

The gas streams may also be modified for the purpose of the invention by use of suitable nozzle shapes and sizes. The nozzles of a smoothing device preferably have a diameter of at least 0.05 millimeters to 10 millimeters maximum, particularly preferably 0.1 to 5 millimeters, in particular 0.2 to 2 millimeters or 0.5 to 1 millimeter.

One possibility for improving the smoothing effect is to provide a nozzle system that generates air streams which strike the substrate surface at different spatial directions, and/or which have gradients in the flow velocity in several directions along the surface.

Another measure is the use of nozzles which generate a turbulent gas stream. For this purpose turbulators may be provided, for example in the nozzle(s), which create turbulence in the gas stream.

The gas stream(s) may also be acted on by ultrasonic waves.

It may also be advantageous for a preferred direction to be present for the deflection of the gas stream by the substrate along the surface thereof. For this purpose, in addition to gas streams which strike perpendicularly, the gas stream(s) are also preferably directed onto the substrate surface at an oblique angle. To this end, the angle of the gas stream is greater than 0° to 90°, preferably in a range of 10° or 20° to 80°, preferably in a range of 30° to 70°, particularly preferably in a range of 40° to 60°, measured from a perpendicular to the surface.

A further measure is to pulse the gas stream(s) instead of uniformly discharging same from the nozzle(s).

In addition, a device may be provided for gridding the gas stream(s) over at least a respective partial region of the substrate surface. In this manner the entire surface to be smoothed may still be swept over by using one or more gas streams, each having flow gradients in multiple directions along the surface.

It has been shown that crater-like depressions appear in particular at small layer thicknesses, depending on the type of substrate. Use of the invention is therefore particularly suited for thinner coating films. One refinement of the invention provides that a film having a layer thickness less than 100 micrometers, preferably less than 50 micrometers, particularly preferably less than 30 micrometers, is applied, and is smoothed before it solidifies. Even very thin coatings having layer thicknesses less than 20 micrometers, even less than 10 micrometers, may be smoothed with elimination of depressions and/or openings. Even coating surfaces of films having layer thicknesses of less than 5 micrometers may be positively influenced by use of the method according to the invention.

Smoothing of a film of still fluid coating material may be considered as targeted influencing of the surface structure, in which crater-like depressions or structures which are transferred from the substrate or by the coating method are removed or closed by use of the gas stream. At the same time, new structures which may be desired may also be created, for example to impart a special appearance and/or feel to the cured film. For this purpose, the angle of impact and flow velocity of the gas stream are modified in such a way that not only are smaller depressions smoothed, but at the same time additional structures are also created by localized displacement and/or shifting of the coating material. Such structures created in a targeted manner may be crimped structures, corrugations, depressions, ribs, or grooves, among others.

In one particularly preferred refinement of the invention, after the targeted influencing of the surface, for example the smoothing, the film is brought into a solid form by use of a separate curing or drying device for curing or drying the coating material. For this purpose, this device is placed downstream from the device for influencing the surface, in the direction of travel, so that the substrate surface first passes by the coating unit, then the device for influencing the surface, and then the curing device. It is particularly suitable to apply coatings which are curable by UV light, such as UV overprint varnish in particular, and to cure the coating material by irradiation with UV light after the smoothing. Accordingly, in this refinement of the invention the curing device includes a light source, preferably a UV light source.

Alternative or additional possibilities for curing after the targeted influencing are heating in an oven and/or using a radiant heater and/or using a microwave source. For curing by heating, known thermally crosslinkable or curable systems, for example, may be used. Thermally crosslinkable coatings, the same as UV-crosslinkable systems, may be based on acrylates, for example.

To achieve an effective influencing of the surface such as smoothing, for example, it is also beneficial to stay within a certain range of the dynamic viscosity. If the viscosity of the applied coating material is too low, the gas stream may quickly result in blowing and undesired shifting and running of the film at its edges. On the other hand, if the dynamic viscosity is too high, it is possible that undesired structures on the film, such as crater-like depressions in particular, may not be smoothed at the desired rate. In one advantageous refinement of the invention, for this purpose a coating material is applied which at the processing temperature has a dynamic viscosity of at least 10 seconds and 1000 seconds maximum, preferably 500 seconds maximum, particularly preferably 200 seconds maximum or even 100 seconds maximum, measured as the runout time of a volume of 100 cm³ from a DIN cup having a discharge nozzle 4 millimeters in diameter. The viscosity may also be adjusted by adjusting the temperature, thus allowing high-viscosity or low-viscosity coating materials to be applied and smoothed.

The targeted influencing of the surface using a gas stream, such as an air stream in particular, represents the particularly preferred manner of influencing the surface because it is very effective and simple. However, other methods have been also been found which likewise allow the surface to be influenced in a simple and effective manner. According to a further alternative or additional embodiment of the invention, an apparatus for applying coatings to surfaces of substrates is provided which likewise includes a coating unit for applying coating material in fluid form, and a conveying device, in order to pass the substrate surface relative to the coating unit along a direction of travel past the coating unit, once again preferably by moving the substrate past a stationary coating unit.

A device is provided for the targeted influencing of the coating surface, in particular for smoothing of the still fluid film applied to the substrate surface by use of the coating unit, whereby the device for the targeted influencing of the surface of the fluid coating material includes a system of needles which make contact for influencing the surface, in particular for smoothing the surface. For this purpose, the needles may in particular puncture the film. Puncturing by the needles causes a localized motion of the liquid coating material, by means of which nonuniformities in the surface may be evened out at the puncture site or in areas near the puncture site.

Use is made of the interfacial tension between the liquid and the needle, which results in adhesion of the liquid coating material to the needles. When the needle is removed from the material, the material which has thus accumulated on the needle flows once more. In particular, once again crater-like depressions, which occur with certain substrate materials and contactless coating, may also be closed. Since the needles contact the film only in places, at best little coating material is distributed as a result of the repeated puncturing and contacting of needles on uncoated areas of the substrate surface. The problems which arise during smoothing with a roller or doctor blade are thus avoided, the same as with smoothing using a gas stream.

With regard to the design of the coating unit and the curing unit, the apparatus may have the same design as the apparatus described above. In addition to contactless coating, alternatively or additionally, for example, a device for roller application, such as for simple, full-surface flexographic or rotogravure printing application, or for screen printing, may be provided.

One particularly preferred embodiment of the device for the targeted influencing of the surface of the fluid coating material provides a roller equipped with needles or a belt equipped with needles which rolls over the film. The rolling prevents the needle tips from moving along the film, which in turn prevents incorporation of undesired structures in the form of striations in the film.

In general, the needles may also be controlled by an actuator so that they make targeted contact with the film in places or in a specified pattern.

To further improve the effect of the device for the targeted influencing of the surface of the fluid coating material, according to another refinement of the invention an ultrasonic oscillator may be provided which is connected to the needles. In this manner the needles are acted on by ultrasonic oscillations transmitted via the needle tips into the film.

The needles may also be selectively controlled by electromechanical devices such as piezo control or suitable actuation under compressed air, for example, in order, for example, to contact only areas on which coating material has been applied. The piezo or compressed air control may also be used, for example, to produce a vertical or lateral motion of the needles to extend or support the smoothing effect. In addition, this motion for partial coating may at least reduce glazing of the coating film.

According to a further alternative or additional embodiment of the invention, targeted influencing of the surface of the film is provided by means of targeted contactless heating by the device for the targeted influencing of the surface of the fluid coating material.

In general, for the method according to the invention for applying coatings to surfaces of substrates,
coating material in fluid form is applied using a coating unit, while
by use of a conveying device the substrate surface relative to the coating unit is moved along a direction of travel past the coating unit, preferably by moving the substrate past a stationary coating unit,
wherein the still fluid film applied to the substrate surface by the coating unit is influenced in a targeted manner before it solidifies, wherein
at least one of the following measures is carried out for influencing the coating surface:
a gas stream is generated and is directed onto the substrate surface coated with the film,
the film surface is contacted using a system of needles,
the film is heated in a contactless manner.

The heating may be carried out using an oven, a radiation source (an IR emitter, for example), preferably a laser, and/or using a device for generating electromagnetic radiation of another wavelength, preferably microwaves.

The individual smoothing methods may also be combined with one another. Thus, among other possibilities a heating device may be provided for heating the at least one gas stream, so that smoothing is carried out using a heated gas stream. Suitable gas stream temperatures are in the range of 0 to 500° C., preferably in the range of 100 to 400° C., particularly preferably in the range of 150 to 300° C. In addition to blowing of the surface using one or more gas streams, separate heating, such as by use of a suitable radiation source or also microwaves, may be carried out.

If a source for generating electromagnetic radiation is used for localized heating, a device for gridding the beam(s) over the substrate surface or at least a partial region thereof may be provided. In this manner it is possible for an energized, locally delimited beam, or a plurality of such beams, to sweep over the entire surface to be smoothed.

In principle, coated surfaces composed of any material and having any shape may be the object of the targeted influencing of the still liquid coating surface, preferably smoothing by use of the apparatus according to the invention.

The apparatus may be designed in particular for coating paper, cardboard, or plastic films. The coating, preferably finishing, of printed materials is intended in particular. Otherwise, the problem often arises, in particular for substrates such as paper or cardboard which have a certain porosity, that crater-like depressions occur in the coating, in the present case in particular also in conjunction with application of the coating material in the drop-on-demand process or another contactless coating method.

In general, it is also intended to use the apparatus according to the invention in a printing machine, such as an offset, flexographic, rotogravure, or screen printing machine. In this manner printed materials may be printed and finished in a single facility. It is also intended to retrofit a coating apparatus, such as a printing machine having a coating group, i.e., a coating apparatus having a device for the targeted influencing of the surface of the fluid coating materials, so that a coating apparatus according to the invention is obtained. Likewise, a printing machine, regardless of the printing method used, may be retrofitted with a coating group which contains a device according to the invention for the targeted influencing of the coating surface.

### BRIEF DESCRIPTION OF THE DRAWINGS

The invention is explained in greater detail below on the basis of exemplary embodiments and with reference to the accompanying figures. Identical or similar parts are denoted by the same reference numerals. The figures show the following:

FIG. 1 shows a schematic view of an apparatus for finishing printed materials having coating films;

FIG. 2 shows a view of a sheet-fed offset printing machine having a coating unit for application and smoothing of varnish;

FIG. 3 shows a schematic view of a further exemplary embodiment of a coating device;

FIG. 4 shows portions of a device for the targeted influencing of surfaces of liquid coating films;

FIGS. 5A and 5B show gridded illustrations of a coating film before and after the targeted influencing of the surface;

FIG. 6 shows a further embodiment of a device for the targeted influencing of coating surfaces, by use of which smoothing is performed by localized heating of the coating material;

FIG. 7 shows an electron micrograph of a crater-like depression in an applied coating film before the targeted influencing using the method according to the invention;

FIG. 8 shows a plot of crater-like depressions as shown in FIG. 7, imaged using white light microscopy; and

FIG. 9 shows a cross section of the two crater-like depressions from FIG. 8.

### DETAILED DESCRIPTION

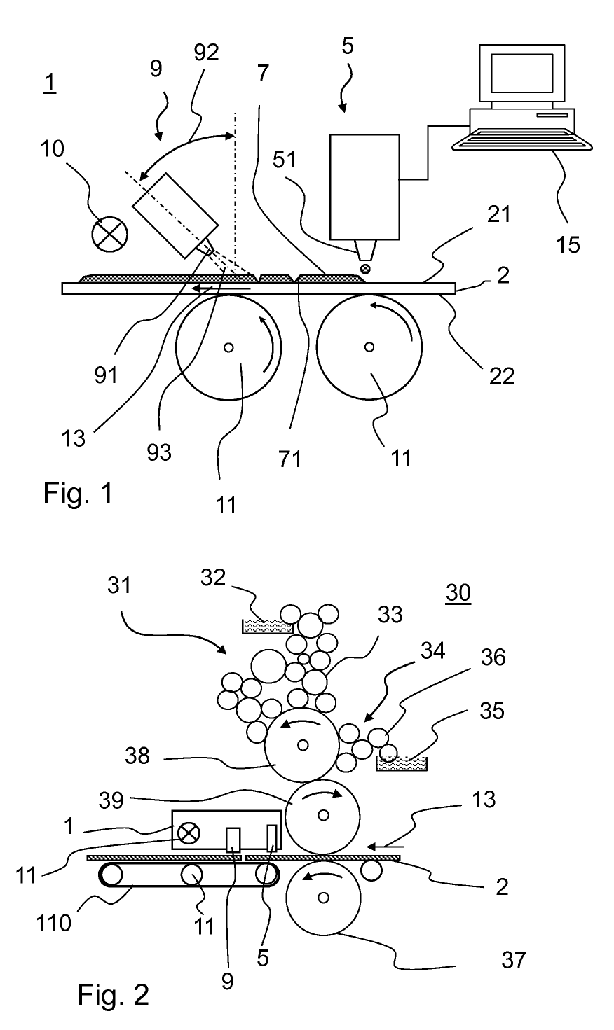

FIG. 1 shows an exemplary embodiment of an apparatus 1 for finishing printed materials.

For this purpose, the apparatus 1 is used to apply a coating to the surface 21 of a preferably printed paper or cardboard substrate 2. To this end a conveying device is provided, which in the illustrated example includes rollers 11 over which the substrate 2 is moved along a direction of travel 13, contacting at the side 22, past a coating unit 5 in the form of a coating group. The coating unit 5 applies a film 7 composed of initially still fluid coating material in the form of a UV-curable coating controlled by a computer 15.

The coating unit 5 operates according to the drop-on-demand principle, wherein the nozzles 51 of the coating unit 5 eject individual droplets onto the substrate surface 21 to be coated in response to control signals from the computer 15, and the droplets form a preferably continuous film. The nozzles 51 are arranged in a row transverse to the direction of travel, wherein the row spans at least ¾ of the width, preferably the entire width, of the substrate 2. To allow high coating speeds to be achieved, a system of nozzles 51 is preferably used which for the coating is rigidly mounted in the direction transverse to the direction of travel.

In a departure from the illustration in FIG. 1, multiple rows of nozzles may also be provided one behind the other in the direction of travel.

Also provided, downstream from the coating unit in the direction of travel, is a device 9 for the targeted influencing of the coating surface, for example for smoothing the surface. This device includes a row of nozzles 91 which are directed onto the substrate surface. The row of nozzles 91, the same as the at least one row of coating nozzles 51, extends transverse to the direction of travel 13.

The nozzles 91 of this device 9 are connected to at least one compressed air source, so that air streams 93 discharge from the nozzles 91 and strike the substrate surface 21, i.e., the film applied thereto. The preferably turbulent air streams cause a slight horizontal shift in the film 7, thereby closing crater-like depressions 71 which are created in the drop-on-demand coating of the porous paper or cardboard substrate 2. To further improve the smoothing effect, it may be practical to pulse and/or heat the air streams, and/or to provide one or more ultrasonic oscillators in the gas supply for the nozzles 91 in order to impinge the air streams 93 with ultrasonic waves.

The smoothing effect of the air streams is also improved by orienting the axes of the nozzles, or accordingly, the exiting air streams, obliquely at an angle 92 relative to the perpendicular to the side 21 of the substrate 2. The angle 92 is between 0° and 90°, preferably between 20° and 80°, in particular between 30° and 70°, particularly preferably between 40° and 60°.

An improvement in the smoothing effect is already achieved by providing multiple discrete gas streams via the plurality of nozzles and/or gradients in the flow velocity in multiple directions along the surface instead of a single gas stream, which may be generated using a slot die, for example.

After the film 7 has been smoothed by means of the air streams 91 from the device 9, the film is cured. For this purpose a curing device for curing the coating material is provided downstream from the device 9 in the direction of travel. In the illustrated example, the curing device includes a UV light source 10. This light source emits UV light having a spectrum which in combination with the photoinitiator used is suitable for the curing reaction.

The UV light from the UV light source 10 initiates radical polymerization of the UV varnish, which at that point is still fluid. UV-curing coatings based on acrylate, for example, are suitable.

The apparatus 1 may be more than an apparatus for finishing printed materials. According to one variant, the printed materials may also be produced using the apparatus, wherein printing inks are applied as coating using the nozzles 51 of the coating unit 5, and the surface of the printed materials is then smoothed using the device 9. In this case as well, UV-curing printing inks may be used which are then solidified by the UV light from the UV light source 10.

FIG. 2 shows a further exemplary embodiment in which an apparatus 1 according to the invention is integrated into an offset printing machine 30. In the illustrated example, the offset printing machine 30 is designed as a sheet-fed offset printing machine for imprinting substrates 2 in the form of individual paper or cardboard sheets. However, a roller offset printing machine may also be used. The printing machine 30 includes an inking unit 31 by means of which ink 32 is applied to the plate cylinder 38 via a series of rollers 33. The printing plate is mounted on the plate cylinder 38. A dampening unit 34 applies water 35 to the printing plate on the plate cylinder 38 via a further system of rollers 36, thereby displacing the ink from the unprinted areas on the printing plate. The printed image is transferred from the plate cylinder 38 to the printing cylinder 39 provided with a rubber blanket. The printing cylinder then applies the printing ink, i.e., the printed image, to the substrates 2 which are pressed against the printing cylinder by means of a counter-pressure cylinder 37 and are conveyed through the printing machine 30 along the direction of travel 13. A coating apparatus as illustrated in FIG. 1, for example, is provided downstream from the printing cylinder 39 in the direction of travel 13. The coating apparatus 1 accordingly includes a coating unit 5 for the structured application of coating material, a unit 9 used to smooth the applied coating film, and a UV light source 10 for curing the optionally structured film of a UV-curing varnish applied by the coating unit 5. The printing machine 30 itself is used as a conveying device. In addition, suitable conveying devices which cooperate in particular with the apparatus 1 or which are a part of same may be provided. In the illustrated example, for this purpose a belt 110 on which the substrates 2 rest and which runs over rollers 11 is provided.

The printing machine 30 may in particular also be retrofitted with an apparatus 1. If the printing machine itself is already alternatively or additionally designed for imprinting for varnish application, it may also be retrofitted with a device 9.

The same as for the example shown in FIG. 1, the device 9 may once again include in particular a system of nozzles for generating gas streams which are used to smooth the coating film.

Instead of an offset printing machine, the apparatus 1 or the device 9 may also be correspondingly incorporated into other printing machines, such as digital printing (ink jet, toner process), screen printing, flexographic, or rotogravure printing machines as well as pad printing machines for printing and/or print finishing, or also into a machine for roller or spray application of varnishes.

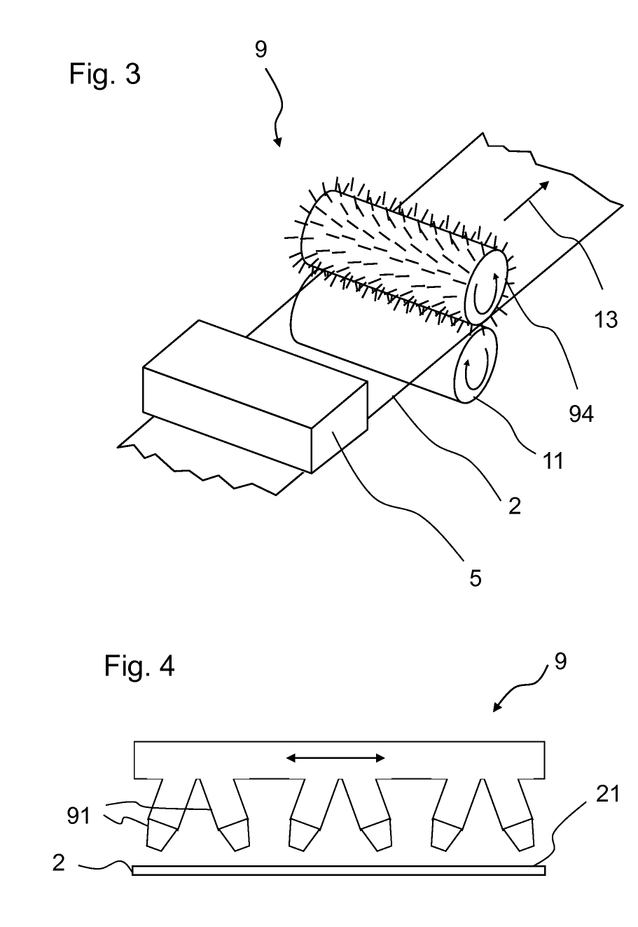

FIG. 3 shows a further exemplary embodiment of a coating apparatus 1.

In this example as well, the coating may be carried out using a coating film for producing structured coating films by use of a coating unit 5 which produces laterally structured films in the drop-on-demand process. In the example illustrated here, a continuous strip is illustrated as the substrate 2.

In contrast to the preceding examples, in the present case instead of a nozzle system the device 9 includes a roller 94 provided with needles. The needles contact the film of the still fluid coating materials when the roller is rolled over. With appropriate process parameters, this results in efficient smoothing of the film surface.

FIG. 4 shows a schematic view of one embodiment of a device 9 which smoothes the still fluid coating film corresponding to the exemplary embodiments shown in FIGS. 1 and 2 by means of gas streams directed onto the substrate surface. FIG. 4 shows a view along the direction of travel of the substrate 2. The same as for the examples shown in FIGS. 1 and 2, the device 9 includes a row of nozzles 91 extending transverse to the direction of travel. The nozzles are also oriented at different angles relative to the perpendicular to the substrate, so that the individual nozzles produce gas streams which have various angles with respect to the substrate 2. In addition, as indicated by the double arrow the device is moved back and forth transverse to the direction of travel of the substrate 2, so that the gas streams successively strike a particular location on the film at different angles, and the gas streams are gridded above the substrate surface. Particularly effective smoothing is achieved in this manner. Of course, gas streams which successively strike a location of the substrate surface at different angles may also be provided using another system. To name only one example, nozzles which precess about the rotational axes may also be used. It is therefore understood that the embodiment illustrated in FIG. 4 is by way of example only. To further improve the smoothing effect, the gas streams may also be pulsed and/or heated and/or acted on by ultrasonic waves.

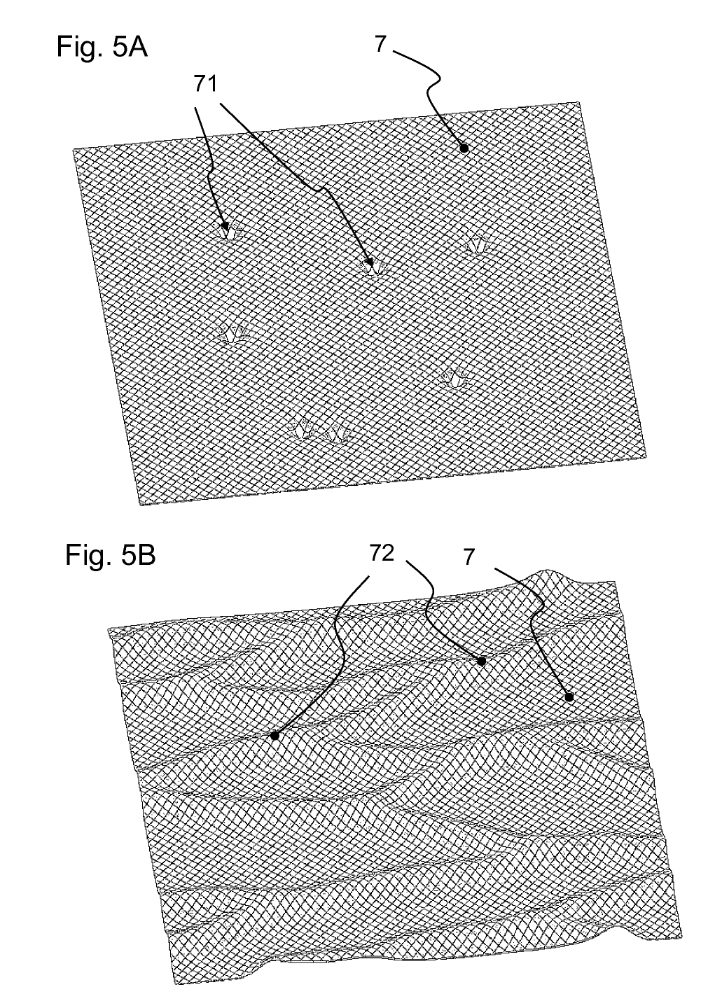

The nozzles 91 may be used for more than smoothing the coating film by eliminating crater-like depressions. Depending on the intensity and/or turbulence of the gas stream and the viscosity of the coating material, it is also possible to introduce structures into the film in a targeted manner. Such an example is illustrated in FIGS. 5A and 5B. FIG. 5A shows a grid illustration of a coating film before the smoothing, as frequently obtained in particular on paper or cardboard substrates by drop-on-demand coating. The crater-like depressions 71 are distributed over the surface of the film 7, and have a diameter which is a function of the layer thickness.

As shown in FIG. 5B, these depressions are closed by blowing the film with gas streams. Instead, relief structuring having ribs or corrugations 72 has been produced in the film 7 by suitable adjustment of the viscosity and the flow velocity of the gas stream. Such targeted structuring may be used to achieve a certain desired haptic and/or optical effect.

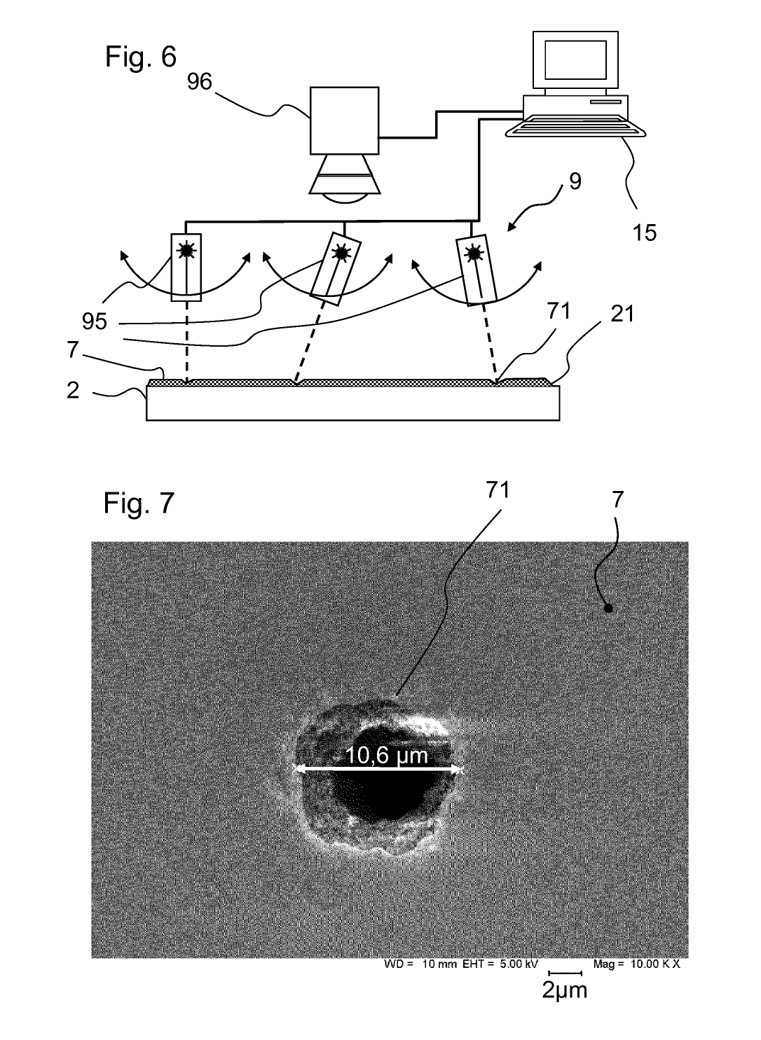

FIG. 6 shows a further example of a device 9. The principle of the device shown here is based on achieving smoothing by targeted, contactless heating. For this purpose one or more radiation sources, for example multiple lasers 95 in the illustrated example, are provided which emit radiation which is at least partially absorbed by the applied coating material or the substrate, thereby heating the film. The lasers 95 are pivotably mounted so that they may be gridded over the substrate surface 21 or respective areas of the substrate surface 21. The swiveling and preferably also the intensity of the lasers are controlled by a computer 15. In the simplest case the surface 21 is scanned by the lasers 95 by swiveling.

However, it is also possible to detect defects in the film 7, such as crater-like depressions 71 in particular, and smooth them in a targeted manner by directing one or more lasers 95 onto the defect. For this purpose, in the example shown in FIG. 6 a camera 96 is provided which is connected to the computer 15. Any defects that are present are recorded by the camera, and their position is determined by the computer. The computer then controls one or more lasers in such a way that the lasers heat the coating material in the region of the defect and thus even out the defect.

This principle may also be applied to the other methods illustrated by way of example in FIGS. 1 through 4. Thus, in one refinement of the invention a device having a detector for detecting the position of defects in the film, preferably using a camera, is provided in general for the targeted influencing of the coating surface. The defects detected by the detector are evened out in a targeted manner by moving or directing the gas stream and/or the radiation source for contactless heating and/or at least one needle.

The crater-like depressions which may be eliminated by means of the invention are characterized in greater detail below by way of example, with reference to measuring results. FIG. 7 shows an electron micrograph of such a depression 71. As indicated by the electron micrograph, the measured depression for the coating shown in this example has a diameter of approximately 10 micrometers.

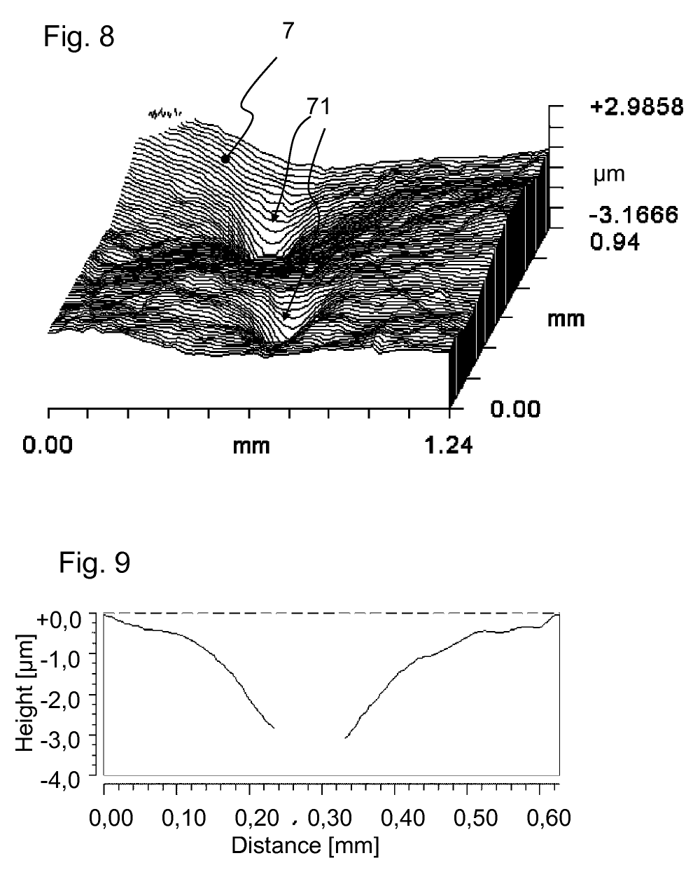

FIG. 8 illustrates a two-dimensional surface profile of another section of a coating film. The surface profile was obtained by white light interferometry. The illustrated section has dimensions of 1.24×0.94 millimeters. Two crater-like depressions are observable in the section shown. In this regard, FIG. 9 further shows a line profile through the larger of the two depressions (in the viewing angle in FIG. 8, this is the rearmost of the two depressions 71). The line profile shows that the depression has external dimensions of approximately 0.3 millimeters. This dimension is obtained from an approximation of the shape of the depression as conical or frustoconical. It is apparent that the pinholes 71 are very deep, having a cross section which tapers toward the substrate. In particular, it was not possible to determine the actual depth by white light interferometry because the measuring range capabilities were exceeded. However, the determined values indicate that the depressions extend to the substrate, which may also be inferred from the appearance of the depressions. In general, these types of depressions in particular may be closed using the method according to the invention.

In general, the crater diameter is a function of the layer thickness, and may also be larger than in the example shown in FIG. 8. It is assumed that these crater-like depressions are based on small chemical and/or topographical defects on the substrate. The depression then diverges upwardly in the shape of a funnel. The curvature of the funnel wall is a function of the surface tension. Consequently, a greater layer thickness does not result, for example, in improved appearance of the coating; rather, the depressions are more prominent with increasing layer thickness since their diameter at the coating surface is greater.

Above a layer thickness of 2 μm, craters such as in the example shown in FIG. 8 are visible to the human eye and detract from the appearance of a continuous coated surface. Although their thickness decreases with increasing layer thickness, their diameter at the surface increases, as stated.

Accordingly, the targeted influencing of the film surface according to the invention is particularly suited for closure of depressions greater than approximately 2 micrometers in diameter, preferably 5 micrometers in diameter, at the surface. Above this diameter, depressions detract from the appearance of the varnish or coating. As explained in the above example, the diameter of the crater-like depressions at the surface may also extend into the millimeter range. Even such large defects may be at least partially eliminated by means of the invention. However, the coating material is not moved over large distances. The coating material is preferably moved laterally by the smoothing device by less than 1 millimeter, particularly preferably by less than 0.25 millimeter. In particular, the edges of uncoated areas are preferably not influenced, thereby maintaining sharp contours at the edges.

It is obvious to one skilled in the art that the invention is not limited to the present exemplary embodiments, but, rather, may be varied in numerous ways. In particular, the individual features of the exemplary embodiments may also be combined with one another.

What is claimed is:

1. Apparatus for applying coating material to a substrate surface, comprising:
a coating unit for applying the coating material in fluid form to the substrate surface, and
a conveying device for moving the substrate surface relative to the coating unit along a direction of travel past the coating unit, and
a device for smoothing the still fluid film applied to the substrate surface by the coating unit, the device including a unit for generating a gas stream which is directed onto the substrate surface coated with the film, and which smoothes the film while at least partially removing interfering structures on the film surface before the coating material cures.

2. Apparatus according to claim 1, characterized in that the coating unit is designed as a drop-on-demand coating unit having nozzles for delivery of individual droplets of the coating material in response to control signals, the nozzle system applying the coating material to the substrate surface in a contactless manner, and the nozzles of the coating unit being arranged in at least one row extending transverse to the direction of travel and spanning at least three-fourths of the processable substrate width perpendicular to the direction of travel, and the nozzles being rigidly mounted in the direction transverse to the direction of travel, and having a computer-supported control device for actuating the nozzles.

3. Apparatus according to claim 1, characterized in that the coating unit includes one of the following devices:
a device for roller application,
a rotogravure printing unit,
a flexographic printing unit,
a screen printing unit,
a digital printing unit,
a pad printing unit.

4. Apparatus according to claim 1, characterized in that the smoothing device includes a device for generating a gas stream and having at least one row of gas nozzles extending transverse to the direction of travel.

5. Apparatus according to claim 1, characterized in that the smoothing device includes a device for generating a gas stream which strikes the substrate surface at an oblique angle, measured from a perpendicular to the surface.

6. Apparatus according to claim 1, characterized in that the device for generating a gas stream includes at least one of the following devices:
a device for generating a pulsed gas stream,
a heating device for heating the at least one gas stream,
a device for gridding the gas stream over at least a partial region of the substrate surface,
a device for impinging the gas stream with ultrasound waves, and
at least one nozzle for generating a turbulent gas stream.

7. Apparatus according to claim 1, characterized in that the smoothing device includes a nozzle system that generates air streams which strike the substrate surface at different spatial directions, and/or which have gradients in the flow velocity in several directions along the surface.

8. Apparatus according to claim 1, characterized by a curing device for curing the coating material, provided downstream from the smoothing device in the direction of travel, the curing device including a UV light source and/or an oven and/or a radiant heater and/or a microwave source.

9. Apparatus according to claim 1, characterized by a detector for detecting the position of defects in the film and a device for moving the gas stream onto the defects.

10. Apparatus according to claim 1, designed as an offset printing, rotogravure printing, flexographic printing, screen printing, digital printing, or pad printing machine.

11. Method for applying coating material to a substrate surface, comprising:
applying the coating material in fluid form using a coating unit, while
moving, by use of a conveying device, the substrate surface relative to the coating unit along a direction of travel past the coating unit, and
smoothing the still fluid film applied to the substrate surface by the coating unit before it solidifies, wherein for the smoothing a gas stream is generated and is directed onto the substrate surface coated with the film.

12. Method according to claim 11, characterized in that the coating material is applied to the substrate surface in a contactless manner using a nozzle system, the nozzles being actuated by a computer-supported control device and the film being applied using the drop-on-demand process, in that the nozzles each deliver individual droplets of the coating material in response to control signals.

13. Method according to claim 11, characterized in that the coating material is applied using nozzles arranged in at least one row which extends transverse to the direction of travel and spans at least three-fourths of the processable substrate width perpendicular to the direction of travel, and the nozzles being rigidly mounted in the direction transverse to the direction of travel.

14. Method according to claim 11, characterized in that the coating material is applied by roller or by screen, digital, or pad printing.

15. Method according to claim 11, characterized in that the gas stream is directed onto the substrate using a row of nozzles oriented perpendicular to the direction of travel.

16. Method according to claim 11, characterized in that the film is smoothed using
a turbulent or pulsed gas stream, or a gas stream acted on by ultrasound waves, or
at least one heated gas stream, the at least one gas stream being heated to a temperature in the range of 50 to 500° C., or
a gas stream which strikes the substrate surface at an oblique angle, measured from a perpendicular to the surface, or
gas streams which strike the substrate surface at different spatial directions, and/or which have gradients in the flow velocity in several directions along the surface.

17. Method according to claim 11, characterized in that at least one gas stream for smoothing the film is gridded over at least a partial region of the substrate surface.

18. Method according to claim 11, characterized in that a film having a layer thickness less than 100 micrometers is applied.

19. Method according to claim 11, characterized in that after the smoothing the film is cured using a curing device, wherein after the smoothing a UV-curable coating material or a printing ink is applied, and is cured by irradiation with UV light and/or by heating in an oven and/or using a radiant heater and/or using a microwave source.

20. Method according to claim 11, characterized in that for the targeted influencing of the fluid film targeted structures are added by use of the gas stream.

21. Method according to claim 11, characterized in that a coating material is applied which at the processing temperature has a dynamic viscosity of at least 10 seconds and/or 1000 seconds maximum, measured as the runout time of a volume of 100 cm³ from a DIN cup having a discharge nozzle 4 millimeters in diameter.

22. Method according to claim 11, characterized in that the substrate surface is laterally structured while leaving at least one surface area uncoated.

23. Method according to claim 11, characterized in that the coating material is transported less than 1 mm along the surface by the gas stream.

24. Method according to claim 11, characterized in that depressions are closed by the smoothing.

25. Method, in particular according to claim 11, characterized in that a coating apparatus or a printing machine is retrofitted with a coating apparatus, or a printing machine is retrofitted with a coating unit having a smoothing device for the fluid coating material, resulting in the apparatus according to claim 1.
